(19) United States
(12) Patent Application Publication
(10) Pub. No.: US 2020/0285450 A1
(43) Pub. Date: Sep. 10, 2020

(54) SYSTEM FOR PROVIDING INSTANT PREVIEW OF A MOBILE APPLICATION UNDER DEVELOPMENT

(71) Applicant: MUVI LLC, Liverpool, NY (US)

(72) Inventors: Anshuman Das, Liverpool, NY (US); PRAGYAN PRIYADARSHINI, BHUBANESWAR (IN); SATYA PRAKASH DAS, BHUBANESWAR (IN); ABHINAV MOHANTY, BHUBANESWAR (IN)

(21) Appl. No.: 16/880,753

(22) Filed: May 21, 2020

Related U.S. Application Data
(63) Continuation-in-part of application No. 16/056,599, filed on Aug. 7, 2018.

(51) Int. Cl. G06F 8/34; G06F 8/38; G06F 3/0482

(52) U.S. Cl. CPC G06F 8/34; G06F 3/0482; G06F 8/38

(57) ABSTRACT

A system is provided giving an instant preview of the appearance of a compiled native application on a computing device during an application development process as the application would appear as if installed from a digital distribution platform, without compiling the application. The system includes a database, a processing unit, and a user interface. An application template module may include one or more application templates. An application template is selected and loaded into a content management module. The application templates provide application elements and features that can be included in a native application. The user can select and arrange the application elements. Upon a computer command, the content management module previews an accurate representation of the appearance of the app in the user interface without compiling the app, and the content management modules allows the user to iteratively change the elements to obtain a desired appearance for the app.

### CROSS REFERENCE TO RELATED APPLICATION(S)

This application is a continuation-in-part of U.S. patent application Ser. No. 16/056,599, filed Aug. 7, 2018, the contents of which are incorporated by reference.

### FIELD OF THE INVENTION

A system is disclosed for mobile computer application development, wherein mock-ups of screen content and a user interface of a mobile application are instantly previewed without generating code for the application.

### BACKGROUND

With modern mobile devices such as smartphones, tablets, and wearables, the favored method of presenting information and interacting with users is through mobile applications (“apps”) rather than webpages. Mobile apps are generally felt to have certain advantages, such as better performance than mobile webpages, have an improved user experience that can be more easily controlled than on a webpage, and can offer offline use. Traditional development of apps for mobile devices and certain desktop apps requires new code to be written for each new application. This code is compiled using one of several available tools and should be tested for bugs, and then submitted to a mobile application store and downloaded by the end user. Changes or updates required to traditional development call for modifications to the original code, re-submission to a mobile application store, and a re-download by the end user. This entire process, even for a minor update, requires approximately three weeks at a minimum, in which one week is used to update and test the code by the developers, and then approximately two weeks for vetting by the app stores.

An app developer wishing to develop a mobile application for an iPHONE® mobile phone must create the mobile application using an iOS platform. The app developer also needs to download the XCODE™ integrated development environment (“IDE”). The app developer will also use the COCOA TOUCH application environment. Also, the mobile app must be certified by Apple.

If the app developer wishes to have that mobile application available for an ANDROID® phone, then the app developer must create a new mobile application using an ANDROID operating platform. The app developer will need a JAVA® development kit (“JDK”), ECLIPSE™ IDE, the ANDROID® SDK, and the ANDROID development tools plug-in.

Some of the differences between just these two platforms include multitasking, widgets, application market restrictions (Apple must certify all iOS apps), notifications, multiple hardware devices (only Apple devices use the iOS platform), editable ROMS (the iPHONE® mobile phone has a read-only memory), and setting changes.

Mobile application owners or developers have the option of creating wireframes to check design and working of the mobile application. The wireframe typically lays out the interface of the application and presents visually the way that a user will interact with the application software. From the wireframing, the application development cycle goes through design, layout, coding, manual testing, review, automation testing and build deployment to publish.

With any conventional app development process, the code is typically compiled and uploaded to a device for review. Non-final versions of the code must then be deleted. The process is lengthy and requires various professionals and tools to create and package a native application for iOS or Android. None of the existing systems allows the developers and their clients to get an accurate feel of a mobile app until the app is compiled and possibly published in the play store. This is a shortcoming of prior art purporting to shortcut and streamline the app development process, for example disclosed in U.S. Pat. No. 8,261,231 B1. Therefore, there is a need of a system for providing an accurate and instant preview of a customized mobile application.

### SUMMARY OF THE INVENTION

This invention addresses a need to simulate the look and feel of an app compiled and operating on a mobile device without actually compiling code or publishing the app in an app store. This invention therefore provides a content management system (CMS) providing an environment allowing developers to add and arrange visual elements of a mobile application to a screen, and to display the elements in real time on a mock-up of the application.

The display in the inventive CMS is only a replica of an app. The inventive method does not require writing code compile code nor does the method produce an actual application suitable for uploading on an app store. This method allows developers and customers to view the visual elements of the application for evaluation of a user-interface and other aesthetic features of the app.

This invention is applicable to devices running, for example, iOS, Android, and other Linux-based operating systems, which operate generally on mobile devices such as smartphones, tablets, Chromebook™ computers, IoT (“internet of things”) devices. This invention may also be applicable to app development on full featured operating systems, including Windows and Apple macOS.

Accordingly, in an embodiment, a system is disclosed for providing an instant preview of the appearance of a compiled native application on a computing device during an application development process. In an embodiment, the system includes a database, a processing unit, and a user interface, where the user interface has input (keyboard and mouse) and output (video and audio) for interacting with users of the system. The database may store a plurality of modules comprising one or more of a content management module and an application template module. Other modules may be included also. The application template module includes one or more application templates, and an application template is selected and loaded into the content management module. The application templates provide application elements and features that can be included in a native application. In an embodiment, the content management module presents in the user interface one or more menus and application elements according to the selected application template that are selected and arranged by a user. The selected elements may be stored in the database for access by other modules and other processes. The processing unit processes the elements in the content management module and previews an accurate representation of the appearance of the app in the user interface without compiling the app. In addition, the content management module may allow the user to iteratively change the elements to obtain a desired appearance for the app.

In an embodiment, the system may be presented to users on a website operating a web-based application.

In an embodiment, the application template module running in the content management module is designed to preview a native application operating on an operating system selected from Android, iOS, Windows, macOS, and other lightweight operating systems. In an embodiment, the application template module running in the content management module is designed to preview a native application operating on a computing device selected from a smartphone, a computer tablet, a lightweight Linux computer, an Apple® Macintosh®, and a Windows computer.

In an embodiment, the application template module allows users to update the selected application template, and the customized native application displays a preview of the input content in the updated selected application template on refreshing. The application template module may further comprise a menu module to allow users to create a customized menu for displaying in the selected application template. The application template module may further include a user interface (UI) color scheme module to allow users to select color scheme using a color palette selector, wherein the UI color scheme is adapted by the selected mobile application template.

In an embodiment, the application template is designed for video or audio streaming content. The application template may also provide an e-commerce store.

In an embodiment, the plurality of modules further comprises an application creation module for creating a ready-to-publish application for distribution on digital distribution platforms, wherein the ready-to-publish application comprises the selected application template with the input content and the application creation module is linked to the application template module and the content management module. The application creation module may create a compiled application that can be distributed on a digital distribution platform. The digital distribution platform may be an app store.

### DESCRIPTION OF THE DRAWINGS

FIG. 1 is a flowchart of an overview of the development process of this invention.

FIG. 2 is a block diagram comparing the inventive system with the prior art.

FIG. 3 a block diagram of a system for providing instant preview of a customized mobile application in accordance with an embodiment of this invention.

FIG. 4 is a screenshot showing of the application template module in accordance with an exemplary embodiment of the present invention.

FIG. 5 is a screenshot showing of the content management module in accordance with an exemplary embodiment of the present invention.

FIG. 6 is a screenshot showing of an application module previewing of the input content in the selected application template.

FIG. 7 is a screenshot showing of a menu module in accordance with an embodiment of the present invention; and

FIG. 8 illustrates a screenshot showing of a creation module in accordance with an embodiment of the present invention.

### DETAILED DESCRIPTION

There are two kinds of programming languages that developers use to build desktop, web, and mobile applications: compiled and interpreted. Interpreted languages produce code that a computer can understand immediately. The most obvious example of this are web pages, where for example HTML, Javascript, or PHP code (interpreted languages) is sent to a web browser which interprets the code and displays a web page. Compiled languages produce code that needs to be compiled in order for the machine (computer) to understand. Examples of this type of code are written in Java, Swift, Python, and C++. This type of code is written in a development environment, and must be compiled with a compiler that converts the language code to machine language and creates an app with various ancillary requirements, such as access to memory, networking services, disk drive storage, keyboard input, and graphic output.

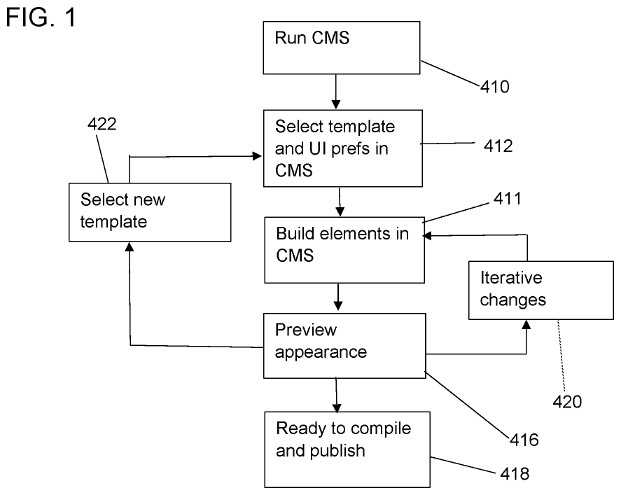

FIG. 1 shows a broad overview of an application (app) development process as disclosed herein. The apps may run on a mobile device, a lightweight operating system, or Windows or Apple Mac operating systems. In an embodiment, the inventive system includes a content management system (CMS) 410 which may be an application with a web-based user interface. A number of templates (412) may be available in the CMS allowing application elements, design variations, and as color schemes, that the developer can select to obtain a desired look and feel for the app. At stage 414, the app is fleshed out with selected elements 414. The look and feel of the app can then be previewed at step 416. The point of this is to show an accurate preview of the visual appearance of the app that may have some limited functionality, such as displaying selected content, to show the developer how the final app will appear, without having to compile code. At step 420, the developer can make iterative changes to change the various elements. At step 422, the developer can select a different template for the CMS and start again at step 412. When the developer is satisfied, the app can be sent to latter stages (418) that compile code into a complete app.

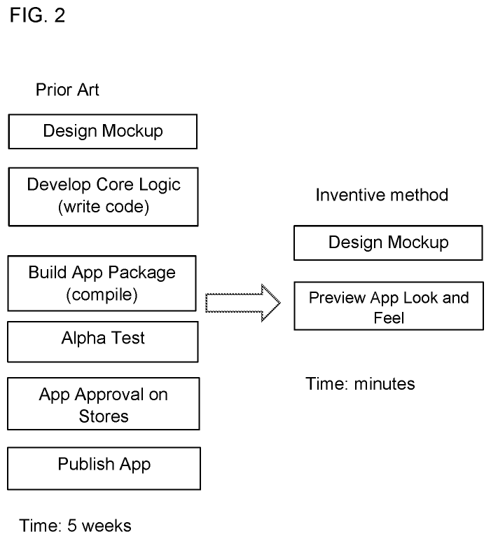

FIG. 2 shows an overview comparing the prior art and the inventive method. Traditional App development cycle ranges anywhere from 5 to 10 weeks, even with reusable modules. Typical app delivery process includes the following steps:
a. Design the screens in photoshop or similar tool (design mock-up)
b. Develop the software keeping the design in mind (write code)
c. Build the APK or IPA file (this is the compilation step)
d. Send to client for testing. Send via email or 3rd part software such as TestFlight
e. Client approves the app
f. Submit to app store; wait for approval
g. Publish the app in app store

This method does not allow the developers and clients to get an actual feel of the mobile application until it is published in an app store. With mobile devices, an APK (compiled file for Android) or IPA (compiled file for iOS) file can be installed on a device in developer mode, but this is a time consuming process requiring substantial extra steps even for experienced developers, and is particularly difficult or impossible for non-experts. Both iOS and Android devices make installing apps off the store intentionally difficult. As used herein, an “app store” means a repository of apps for a particular operating system or device, and includes repositories such as Google Play™, the Apple App Store®, or Samsung Galaxy® Store. Therefore, there is a need of a system for providing customized and instant preview of a mobile application in real time.

Also shown in FIG. 2 is a block diagram of the inventive system, which is a two-step process:
a. Design screens in the CMS
b. Preview the appearance of the design in real time

The prior art takes many weeks to complete. The inventive system can be prototyped and previewed in a few minutes. The preview of the app can be thought of as a simulated view of an actual app.

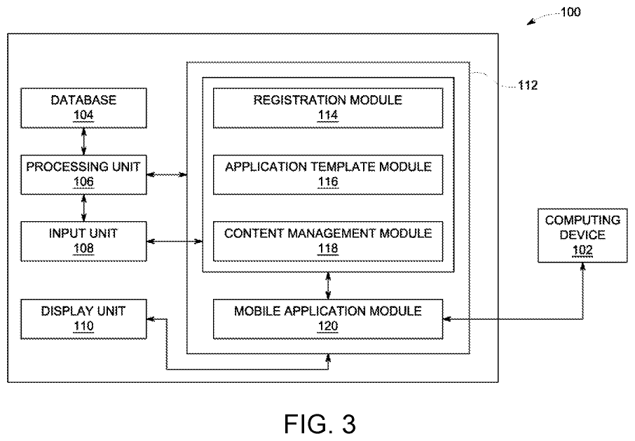

FIG. 3 illustrates a block diagram of a system 100 for providing an instant preview of a customized mobile application in near real time in accordance with an embodiment of the present invention. The system 100 for providing instant preview of a customized mobile application on a computing device 102. In an embodiment, system 100 may be presented to users on a website operating a web-based application (a web app) that may require user registration and payments for use, and that allows users to create apps according to this invention, with instant online preview of visual elements, and bundling of a final version for compiling and publication on an app store. Such a web app would have all the modules required for this invention and may allow users to create new application templates. presented to users on a website running a web-based application

The system 100 may include a database 104, a processing unit 106, an input unit 108 and a display unit 110. Collectively, the input and display units are also referred to as a user interface. The database 104 stores a plurality of modules 112. The database 104 may be either local or remote, for example accessed on a remote network device (on the “cloud”). Examples of the database 104 include but are not limited to MySQL®, Dynamo®, Mongo® etc.

The processing unit 106 is coupled to the database for processing the plurality of modules 112. The plurality of modules 112 may include one or more of a registration module 114, an application template module 116, a content management module 118 and a mobile application module 120. In an embodiment, the processing unit comprises a conventional computing system, with a computer processor, random access memory (RAM), long term non-volatile storage such as a solid state drive, networking hardware and software, and input/output equipment. Networking hardware and software include ethernet (which may be formally known as IEEE 802.3), WiFi (formally known as IEEE 802.11), and universal serial bus (USB).

The registration module 114 registers users to receive a user ID and a password for user authentication. In an embodiment of the invention, the user may register themselves by providing details like first name, last name, social media account, email, phone number etc. This may be important, for example, to create an account on the inventive system so work can be saved from one session to the next. In an embodiment, as discussed elsewhere herein, this entire system may operate on a web server, so files and work will need to be saved on the server. Thus, user accounts will be required. In another embodiment, there may be a payment model requiring users to pay to use the system. This also requires user authentication and billing details.

The application template module 116 allows registered users to select one of several mobile application templates. The templates provide, for example, a framework for the look and feel of an application, including design and layout, fonts, artistic elements, and a color scheme. These are all part of the “look and feel” of an application that can vary depending on the target audience. For example, an app directed at business users will likely have a more business-like look and feel than an app directed at children. The system according to this invention may provide several templates. A selected application template is loaded into the content management module (118).

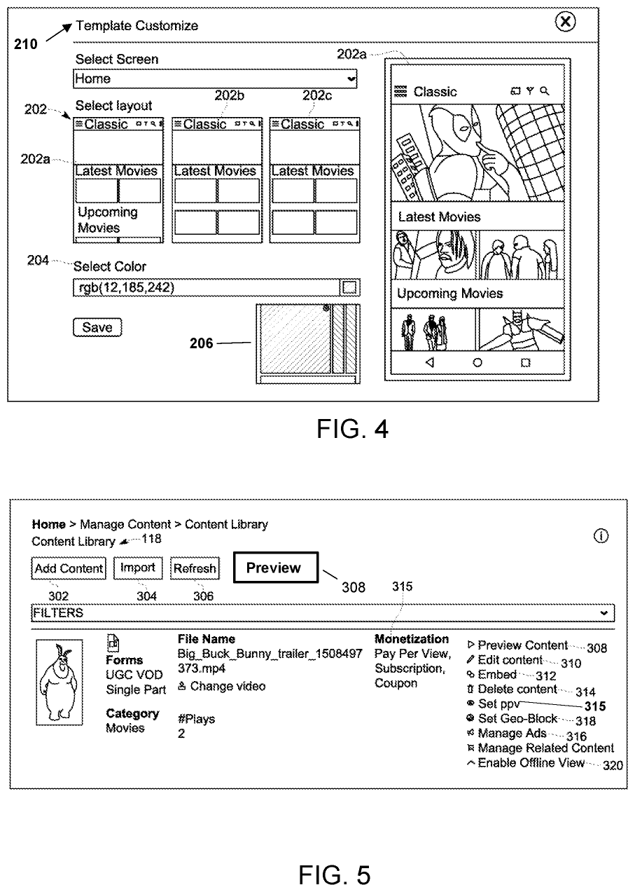

The application template module 116 is explained in further detail in conjunction with FIGS. 4 and 8 of the present invention.

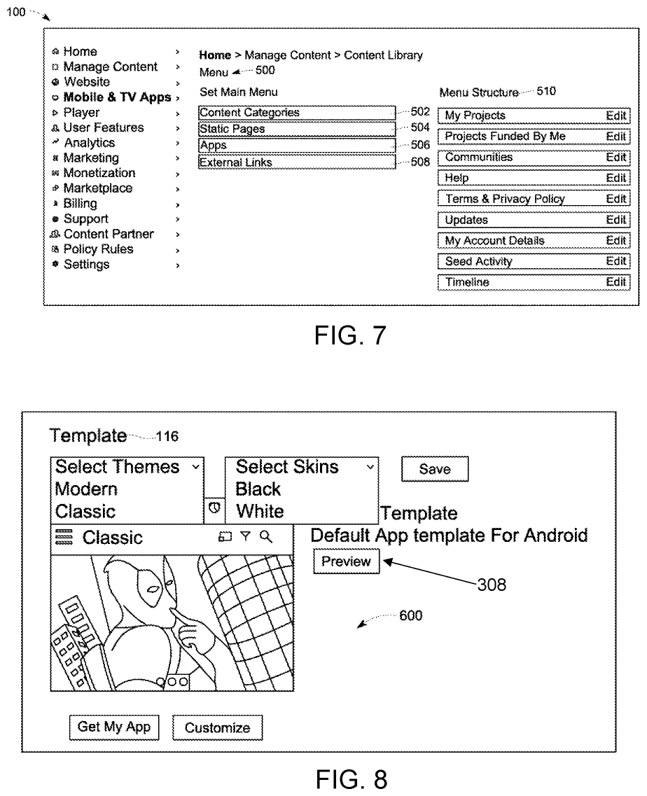

The content management module 118 allows registered users to create elements of an application within the selected template. By the term “elements,” it is meant features such as buttons, menus, drop boxes, lists, links, text, graphics, music, video content display and the like that comprise visual and functional elements of a computer application. The elements, the arrangement and position of elements, and the selected template are stored in the database. The content management module 118 is explained in detail in conjunction with FIGS. 5 and 7 discussed below. In an embodiment, the template is designed for managing, selecting, and displaying video or audio streaming content, this the inventive method is not limited to this type of content. Also within the scope of this invention are the creation of apps that display information or provide interactive methods, such as e-commerce stores, payment systems, weather apps, or transportation schedules. By “e-commerce” it is meant apps that present a menu of products or services that a user can select and purchase. E-commerce apps must also therefore include authentication mechanisms and payment systems, such as accepting credit cards.

The mobile application module 120 may be distributed may be a web application (or web app), that is, a computer software program that is run on a web server, rather than on a local device. Web apps are accessed by a user through a web browser with an active internet connection. These applications are typically programmed using a client-server modeled structure—the user (“client”) is provided services through an off-site server that is hosted by a third-party. The underlying code that generates the webpage is operating on a webserver, that transmits html, javascript, PHP, and other interpreted code to a web browser. Examples of commonly used web applications include email (such as Gmail™), online retail sales, and online banking, which all use active web pages running in a web browser. Examples of web browsers include the Google Chrome™ browser, Mozilla® Firefox®, Apple® Safari®, Microsoft Edge®, and others.

In an embodiment, the mobile application module 120 provides the computer processing that displays an instant preview of the app under development, by sending a graphic representation of the app to the display unit in the user interface. The user (developer or customer) can evaluate the look and feel and make changes in the content management module (also referred to herein as the content management system) as desired and repeat the preview process. In another embodiment, the mobile application module can bundle the app from the content management module for further processing into a compiled application.

The input unit 108 is part of the user interface and allows the user to input content into the content management module 118 and the registration module 114. Further, the input unit 108 allows the user to select one of the templates from the application template module. Examples of an input unit 108 include for example, a keyboard, a mouse, a stylus, and other similar input devices. The display unit 110 is for example, a computer screen, which may be a screen on a smartphone, tablet, computer, larger screen format TV, projector, or any other of various devices that present content from computers for human eyes. The user interface may also include audio devices such as speakers or headphones.

FIG. 4 is a simulated screenshot of an embodiment of an application template module 116 in accordance with an exemplary embodiment of the present invention. The application template modules 116 displays various layouts 202 such as 202a, 202b, 202c. The application template module 116 further displays a preview of the selected layout 202a with a dummy/default content. The examples of application templates include templates for apps designed for Android™, iOS®, Windows®, macOS®, and other lightweight Linux operating systems. By the term “lightweight Linux operating systems” is meant operating systems for devices such as Chromebook™ computers, Roku® devices, Amazon® Fire® devices, and similar devices. Many of these may be used in home theater-type applications, that manage video and audio content for consumers. Templates also include templates designed for operating on a computing device selected from a smartphone, a computer tablet, a lightweight Linux computer, an Apple® Macintosh®, and a Windows computer. Templates may be directed generally to video content, audio content, news or blogs, communication apps, e-commerce apps, etc. The type of app is not limited by the instant invention. In an embodiment, the device may be an “OTT” (over-the-top) device that provides streaming video or audio content to consumers. In an embodiment, the device may be an “IoT” (internet of things) device, that is a network-connected appliance that provides some kind of functionality for residential or commercial use.

In the exemplary embodiment depicted in FIG. 4, a template 210 is shown with layouts 202 providing various options to present video content in a mobile application. The layouts 202 may present with various options such as different types of grids, different number of columns, and different number of rows. It would be readily apparent to those skilled in the art that various type of layouts 202 may be envisioned without deviating from the scope of the present invention. In the exemplary embodiment of FIG. 4, the content is a combination of audio and video file i.e. movies. However, it would be readily apparent to those skilled in the art that the content may be audio, video, photos or combination of each of them, or any other type of app.

In another embodiment of the present invention, the system 100 further includes a user interface (UI) color scheme module 204 to allow the user to select color scheme using a color palette selector 206. The UI color scheme is adapted by the selected mobile application template such as the application template 202a.

In another embodiment of the present invention, the application template module 116 allows users (i.e., developers) to update the application template, shown as 422 in FIG. 1.

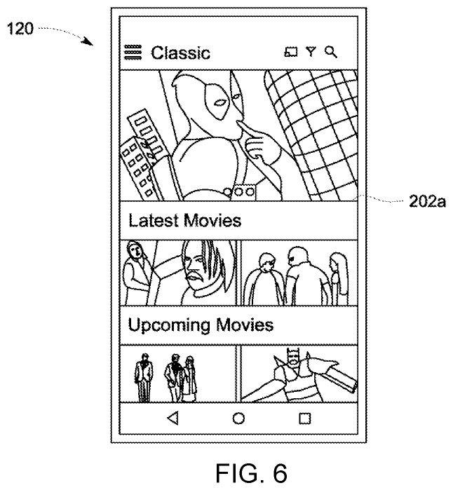

FIG. 5 is a simulated screenshot of the content management module 118 (also called the content management system) in accordance with an exemplary embodiment of the present invention. The content management module 118 allows adding content through an add content tab 302, importing content through an import button 304 either from local database or a cloud, and refreshing the content through a refresh button 306. In an embodiment, the refresh button may activate the inventive preview of the app. In an embodiment, a preview button may be provided to present a preview of the app. An exemplary preview is shown in FIG. 6.

In an embodiment, the user can upload or add content such as audio, video, photos or a combination of audio, video, and photos. For example, this can include content in various formats such as .PNG, .JPEG, .MP4, .MP3, .PDF, SVG, .AAC, .BMP, HLS, .MPEG-DASH etc. It would be apparent to those skilled in the art that various format of content may be envisioned without deviating from the scope of the present invention.

The content management module 118 further allows the user to preview the added or uploaded content in the selected application template using a preview content button 308. That is, the preview button initiates a computer command to preview the appearance of the application as provided in this invention. Further, the content management module 118 allows the user to edit content 310, embed 312 a hyperlink/weblink, and delete 314 a content etc.

In an embodiment, the content management module 118 further includes advertisement (“ad”) management module 316 to allow registered users to create advertisements to be viewed along the content through the application template. The type of advertisements includes, for example, server-side advertisements, client-side advertisements, ad tagging, pay per click, ad exchange, social media campaigns etc. It would be readily apparent to those skilled in the art that various types of advertisements may be enabled in the ad management module 316 without deviating from the scope of the present invention.

Further in another embodiment of the present invention, the content management module 118 further includes a monetization module 315 to allow registered users to access content. The registered users may access content through various payment modes such as pay per view (PPV), vouchers, subscription, coupons, credit etc. It would readily apparent to those skilled in the art that various types of payment modes for accessing content may be envisioned without deviating from the scope of the present invention.

In another embodiment of the present invention, the content management module 118 further includes a set-geo block 318 to restrict the access to the mobile application and advertisements to specified countries or geo-locations.

Further in another embodiment of the present invention, the content management module 118 allows the registered user to download previously uploaded content in the database while in offline mode 320. Further, the customized application retrieved from the mobile application module (120, explained in FIGS. 3 and 6) allows the registered user to preview the selected content while in the offline mode.

In another embodiment of the present invention, the database stores the plurality of content selected in the content management module. The content management module 118 further allows the registered user to manipulate the input content in the database. Further, the customized application retrieved from the mobile application module (120 explained in FIGS. 3 and 6) allows the registered user to preview the manipulated content instantly. Examples of the manipulation include, for example, offline viewing, casting, digital rights management (DRM), translation, device restrictions etc.

The content management module 118 may further allow the user to “cast” the content to a television through devices such as AirPlay® or Chromcast®. The content management module 118 further enables the input content to become available to supported screens. The content management module 118 may further enable DRM protection for content in order to improve security and reduce piracy threats from downloads. In an exemplary embodiment of the present invention, the content management module 118 may secure the input content according to industry standard DRM protocols.

The content management module 118 may further provide options to translate the content in various languages to deliver content with multi-language audiences. Furthermore, the content management module 118 may set device and stream restrictions to the content, so the input content may be consumed by a limited number of devices and users.

FIG. 6 is a screenshot of the application module 120 previewing of the input content in the selected application template 202a. With reference to FIG. 1, the application module 120 is linked to the content management module to retrieve and display content (preview) on the selected application template 202a.

In an embodiment, a tokenized JSON based authentication may be implemented to handshake between the content management module and the application module to ensure security over tradition API authentication. Upon entering the username and password in the application downloaded from the application module, the application is rendered based on the JSON data received in the content management module, making all data dynamically driven from the backend. It would be apparent to those skilled in the art that various other processes can similarly be used to link the application module to handshake with the content management module such as XML, GSON, BSON, Jackson, or any other similar stateless serialized token based authentication.

In an embodiment, users are able to load the application module 120 and develop apps for a digital distribution platform, including an Android® app, iOS® app, Android TV™ App, Fire TV® App, Apple TV® App, Samsung®, LG®, Xbox®, PlayStation®, Roku® and other similar IOT based devices etc. As used herein, a “digital distribution platform” means an app store, but a digital distribution platform can be any app installing or updating system, for example that updates a IoT device or a Roku device.

In an exemplary embodiment of the present invention as shown in FIG. 6, the downloaded application module is a mobile application displaying the content uploaded in the content management module, thus creating a customized application preview instantly in the application module.

The customized application displays the content input into the content management module in the selected application template. The customized application is updated instantly simultaneously to update and refresh of the content management module.

FIG. 7 is a screenshot showing of a menu module 500 as part of an application element. The system 100 may include a menu module 500 to allow users to create a customized menu to be displayed in the selected application template.

The menu module 500 may allow the users to set a main menu in various categories such as content categories 502, static pages 504, apps 506 and external links 508. Further, the menu module allows the user to create menu structure 510 to be displayed on the selected application template. Furthermore, the menu structure 510 allows the user to select option of showing the menu either in horizontal or vertical position.

In the exemplary embodiment of FIG. 7, the menu structure 510 includes “my projects,” “projects funded by me,” “communities,” “help,” “terms and privacy policy,” and so forth. It would be readily apparent to those skilled in the art that various categories may be envisioned under main menu and menu structure 510.

FIG. 8 illustrates a screenshot of a creation module 600 in accordance with another embodiment of this invention, showing an application template specifically designed for Android devices. This illustration further includes an application creation module 600 which is linked to the application template module 116 and the content management module (118, FIGS. 3 and 5) for creating content for ready-to-publish applications (also step 418 of FIG. 1).

In an embodiment, the ready-to-publish application includes the selected application template with the input content. The application creation module may send the ready-to-publish application over a communication network, wherein the ready-to-publish application comprises the selected application template with the input content and elements, for example elements created at step 411 (FIG. 1). The application creation module may be linked to the application template module and the content management module. The application creation module prepares an app prototype according to this invention for conversion to an actual, customized application that is compiled and ready for publication on an app store.

The present invention offers various advantages such as saving time to create a mobile application or an application for another lightweight operating system. This invention may further provide a mobile application with zero coding efforts. Furthermore, the present invention allows the user to instantly preview the desired content in the desired template without creating frameworks, without coding, and without the need for deployment.

Many brand names and trademarks are referred to herein. Over time, many of the marks and services will change, but persons of skill in the art would understand that successor marks and brands may fall within the scope of this invention. The inventors have developed an operational form of this invention called Muvi Onyx™.

1. A system for providing an instant preview of the appearance of a compiled native application on a computing device during an application development process, comprising:
a database, a processing unit, and a user interface;
wherein the database stores a plurality of modules comprising one or more of a content management module and an application template module;
wherein the application template module includes one or more application templates, and an application template is selected and loaded into the content management module, and wherein the application templates provide application elements and features that can be included in a native application;
wherein the content management module presents in the user interface one or more menus and application elements according to the selected application template that are selected and arranged by a user, wherein the selected elements are stored in the database;
wherein the processing unit processes the elements in the content management module and previews an accurate representation of the appearance of the app in the user interface without compiling the app, and the content management module allows the user to iteratively change the elements to obtain a desired appearance for the app.

2. The system according to claim 1, wherein the system is presented to users on a website operating a web-based application.

3. The system according to claim 1, wherein the application template module running in the content management module is designed to preview a native application operating on an operating system selected from Android, iOS, Windows, macOS, and other lightweight operating systems.

4. The system according to claim 1, wherein the application template module running in the content management module is designed to preview a native application operating on a computing device selected from a smartphone, a computer tablet, a lightweight Linux computer, an Apple® Macintosh®, and a Windows computer.

5. The system according to claim 1 wherein the application template module allows users to update the selected application template, and the customized native application displays a preview of the input content in the updated selected application template on refreshing.

6. The system according to claim 1 wherein the application template module further comprises a menu module to allow users to create a customized menu for displaying in the selected application template.

7. The system according to claim 1 wherein the application template module further comprises a user interface (UI) color scheme module to allow users to select color scheme using a color palette selector, wherein the UI color scheme is adapted by the selected mobile application template.

8. The system according to claim 1, wherein the application template is designed for video or audio streaming content.

9. The system according to claim 1, wherein the application template is designed to provide an e-commerce store.

10. The system according to claim 1, wherein the plurality of modules further comprises an application creation module for creating a ready-to-publish application for distribution on digital distribution platforms, and
wherein the ready-to-publish application comprises the selected application template with the input content,
wherein the application creation module is linked to the application template module and the content management module, and wherein the application creation module creates a compiled application that can be distributed on a digital distribution platform.

11. The system according to claim 10, wherein the digital distribution platform is an app store.
